(19) United States
(12) Patent Application Publication
(10) Pub. No.: US 2021/0309874 A1
(43) Pub. Date: Oct. 7, 2021

(54) TEXTILE PRINTING

(71) Applicant: Hewlett-Packard Development Company, L.P., Spring, TX (US)

(72) Inventors: Zhang-Lin ZHOU, San Diego, CA (US); Rodney David STRAMEL, San Diego, CA (US); George SARKIAN, San Diego, CA (US)

(73) Assignee: Hewlett-Packard Development Company, L.P., Spring, TX (US)

(21) Appl. No.: 17/267,607

(22) PCT Filed: Dec. 14, 2018
(86) PCT No.: PCT/US2018/065858

§ 371 Date: Feb. 10, 2021

(51) Int. Cl. C09D 11/102; C09D 11/54; C09D 11/322; C09D 11/101; C09D 11/033; C09D 11/037; D06P 5/30; D06P 5/00; D06P 1/52

(52) U.S. Cl. CPC C09D 11/102; C09D 11/54; C09D 11/322; C09D 11/101; D06P 3/60; C09D 11/037; D06P 5/30; D06P 5/002; D06P 1/5285; C09D 11/033

(57) ABSTRACT

A textile printing system include an ink composition and a fabric substrate. The ink composition includes from 50 wt % to 95 wt % water, from 4 wt % to 49 wt % organic co-solvent, from 0.5 wt % to 12 wt % pigment with a dispersant associated with a surface thereof, and from 0.5 wt % to 20 wt % of a polyurethane particles. The polyurethane particles include a polyurethane strand with a polyurethane backbone with a pendant reactive (meth)acrylate-containing diol group and terminal end cap groups. The terminal end cap groups independently are selected from a monoalcohol, a monoamine, an acrylate, a methacrylate, or a combination thereof.

### BACKGROUND

There are several reasons that inkjet printing has become a popular way of recording images on various media surfaces. Some of these reasons include low printer noise, variable content recording, capability of high speed recording, and multi-color recording. Additionally, these advantages can be obtained at a relatively low price to consumers. Consumer demand can create pressure to develop inkjet printing systems and ink compositions that can print on a wide variety of media quickly and with good image quality. However, in many cases it can be difficult to balance parameters such as image quality, image durability, and so on.

### BRIEF DESCRIPTION OF THE DRAWINGS

FIG. 1A is a schematic diagram of example textile printing systems in accordance with the present disclosure;

FIG. 1B is a schematic diagram of example textile printing systems in accordance with the present disclosure; and

FIG. 2 is a flow diagram of an example method of textile printing in accordance with the present disclosure.

### DETAILED DESCRIPTION

The present disclosure is drawn to textile printing systems and methods. In one example, a textile printing system includes an ink composition and a fabric substrate. The ink composition includes from 50 wt % to 95 wt % water, from 4 wt % to 49 wt % organic co-solvent, from 0.5 wt % to 12 wt % pigment, wherein the pigment has a dispersant associated with a surface thereof, and from 0.5 wt % to 20 wt % of a polyurethane particles. The polyurethane particles include a polyurethane strand including a polyurethane backbone with a pendant reactive (meth)acrylate-containing diol group and terminal end cap groups, and the terminal end cap groups are independently selected from a monoalcohol, a monoamine, an acrylate, a methacrylate, or a combination thereof. In one example, the polyurethane strand can further include a carboxylated- or sulfonated-stabilization group appended thereto. The carboxylated- or sulfonated-stabilization group can include, for example, 3-(cyclohexylamino)-1-propanesulfonic acid attached to the polyurethane strand through a nitrogen, 2-(cyclohexylamino)ethanesulfonic acid attached to the polyurethane strand through a nitrogen, or both. The pendant reactive (meth)acrylate-containing diol groups can be attached to the polyurethane strand or pre-polymer thereof by reaction of the polyurethane strand or pre-polymer thereof with:

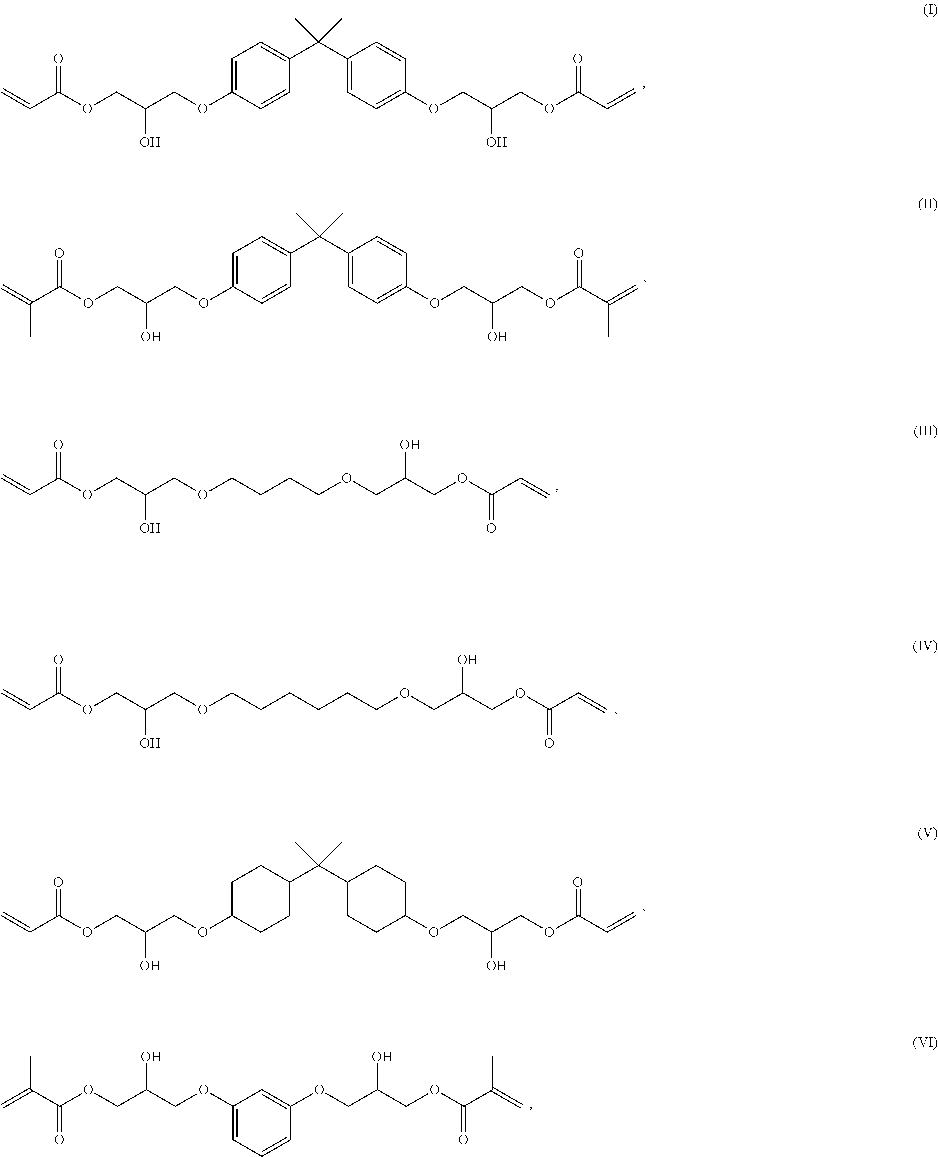

or a combination thereof. In another example, one or both terminal end cap groups can include an acrylate-containing monoalcohol, a methacrylate-containing monoalcohol, an allyl-containing monoalcohol, an allyl-containing monoamine, a styrene-containing monoalcohol, an acrylamide-containing monoalcohol, or a methacrylamide-containing monoalcohol. Furthermore, one or both terminal end cap groups can include a monoalcohol or monoamine at ends of the polyurethane strand and are attached by reaction of the polyurethane strand or pre-polymer thereof with:

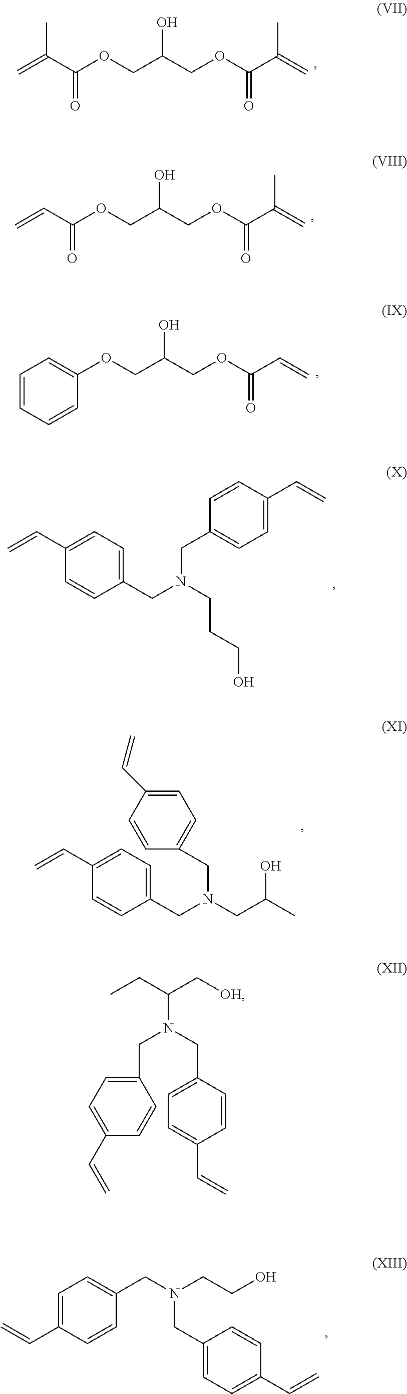

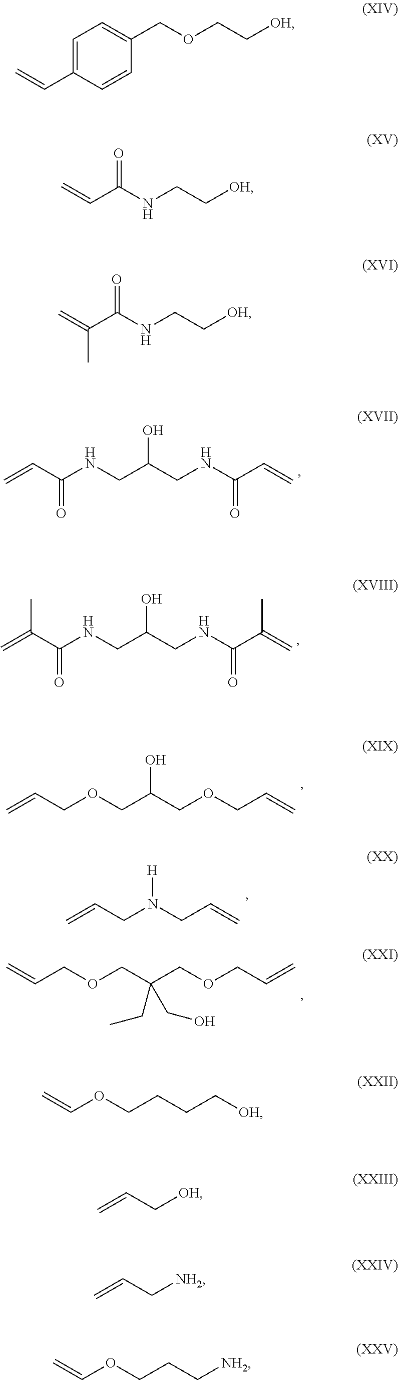

or a combination thereof. The ink composition can further include, for example, a photo-initiator, a sensitizer, or both. The fabric substrate can include cotton, polyester, silk, nylon, or a blend thereof.

In another example, a method of textile printing includes jetting an ink composition onto a fabric substrate. The ink composition includes from 50 wt % to 95 wt % water, from 4 wt % to 49 wt % organic co-solvent, from 0.5 wt % to 12 wt % pigment with a dispersant associated with a surface thereof, and from 0.5 wt % to 20 wt % of a polyurethane particles. The polyurethane particles include a polyurethane strand including a polyurethane backbone with a pendant reactive (meth)acrylate-containing diol group and terminal end cap groups. The terminal end cap groups are independently selected from a monoalcohol, a monoamine, an acrylate, a methacrylate, or a combination thereof. In further detail, the polyurethane strand can further includes a carboxylated- or sulfonated-stabilization group appended thereto. The method can also include heating the ink composition on the fabric substrate at from 120° C. to 250° C. for from 1 second to 5 minutes. In another example, the method can include underprinting or overprinting a binder fluid on the fabric substrate with respect to the ink composition. The binder fluid can be devoid of pigment and includes from 2 wt % to 30 wt % of the polyurethane particles dispersed therein. The fabric substrate can include cotton, polyester, silk, nylon, or a blend thereof.

In still another example, a textile printing system includes an ink composition, a binder fluid that is devoid of pigment and includes from 2 wt % to 30 wt % of the polyurethane particles dispersed therein, and a fabric substrate. The ink composition includes from 50 wt % to 95 wt % water, from 4 wt % to 49 wt % organic co-solvent, from 0.5 wt % to 12 wt % pigment, wherein the pigment has a dispersant associated with a surface thereof, and from 0.5 wt % to 20 wt % of a polyurethane particles. The polyurethane particles include a polyurethane strand including a polyurethane backbone with a pendant reactive (meth)acrylate-containing diol group and terminal end cap groups. The terminal end cap groups are independently selected from a monoalcohol, a monoamine, an acrylate, a methacrylate, or a combination thereof. In one example, the fabric substrate can include cotton, polyester, nylon, or a blend thereof.

As will be described in more detail below, in some examples, the ink compositions can include polyurethane particles. Even though these polyurethane particles can be cured with application of UV-energy and/or heat, for example, these polyurethane particles have been found to be durable even without affirmative curing. Simply drying the ink compositions of the present discourse with these polyurethane particles can provide good durability on a variety of fabrics, including cotton, polyester, silk, nylon, or a blend thereof. Furthermore, it has been experimentally determined that the addition of photo-imitator and/or sensitizer can improve further the durability of the ink compositions of the present disclosure, again even without implementation of an affirmative curing step, e.g., UV-curing and/or heating. This can be particularly true when the fabric substrate is other than a cotton-based fabric substrate, e.g., silk and/or nylon. Thus, when printed, the ink composition includes the polyurethane particles that can form a protective film with good durability. Furthermore, the polyurethane particles, the dispersed pigment, and ink vehicle can be formulated to allow for good jettability, including good decap performance.

The polyurethane particles can be added to an aqueous liquid vehicle such that dispersed polyurethane particles of a polyurethane particle dispersion likewise become dispersed in the liquid vehicle. In some more specific examples, the polyurethane can include a polymer strand including a polymer backbone having two ends terminating at a first cap group and a second cap group. The polymer backbone can be formed by reacting a diisocyanate with a diol. In this reaction, the hydroxyl groups of the diol react with the isocyanate groups of the diisocyanate to form urethane linkages. In this way, a strand of polymerized diisocyanate and diol monomers can be formed. In some particular examples, the diol used to form the polymer strands described herein can be a reactive diol selected from an acrylate-containing diol or a methacrylate-containing diol. As used herein, “acrylate-containing diol” refers to a chemical compound that has two hydroxyl groups and an acrylate functional group. Similarly, “methacrylate-containing diol” refers to a diol compound that includes a methacrylate functional group. The acrylate or methacrylate groups on the diol segments of the polymer strand can be available for crosslinking.

The cap groups can be added at the ends of the polymer backbone. In some examples, the cap groups can be formed by reacting a monoalcohol or monoamine with an isocyanate group at the end of a polymer backbone. Because the monoalcohol or monoamine has only one hydroxyl or amino group to react with the isocyanate group, these cap groups stop the polymerization of the polymer backbone and terminate the polymer strand. In some examples, the polymer strand can include a first cap group and a second cap group. The first cap group can include a monoalcohol or monoamine reacted with an isocyanate group at the end of a polymer backbone, where the monoalcohol or monoamine is selected from an acrylate-containing monoalcohol, a methacrylate-containing monoalcohol, an allyl-containing monoalcohol, an allyl-containing monoamine, a styrene-containing monoalcohol, an acrylamide-containing monoalcohol, or a methacrylamide-containing monoalcohol. One or both of the end cap groups, such as the second end cap group in one example, can be formed by reacting 3-(cyclohexylamino)-1-propanesulfonic acid (CAPS) or 2-(cyclohexylamino)ethanesulfonic acid (CHES) with an isocyanate group at the other end of the polymer backbone.

In some examples, the polymer backbone can be devoid of ionic stabilizing groups such as acid groups. In these examples, the monomers used to form the polymer backbone can be devoid of ionic groups. While the polymer backbone may be devoid of ionic stabilizing groups, the cap groups can include ionic stabilizing groups to help disperse the polyurethane in the aqueous liquid vehicle, or in some examples, there may be pendent groups that include ionic stabilizing groups, such as sulfonate and/or carboxylate groups.

To clarify, as mentioned, the polyurethane particles can include a polyurethane strand with a polyurethane backbone having a pendant reactive (meth)acrylate-containing diol group and terminal end cap groups, and the terminal end cap groups can independently be selected from a monoalcohol, a monoamine, an acrylate, a methacrylate, or a combination thereof. However, in one more specific example structure of a polymer strand of the polyurethane particles, Formula (XXVI) shows an example of a general chemical structure, as follows:

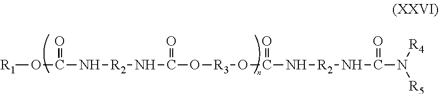

In Formula (XXVI), R₁, R₂, R₃, R₄, and R₅ can correspond to the following groups: R₁ can be an organic group that includes an acrylate, methacrylate, allyl, styrene, acrylamide, or methacrylamide functional group. This can be the first cap group, which can be formed by reacting a monoalcohol having the formula R₁—OH with an isocyanate group at the end of the polymer backbone. In other examples, the first cap groups can be formed by reacting a monoamine of the formula R₁—NH₂ with the isocyanate group, in which case the cap group would be linked to the polymer backbone through a —NH group instead of an oxygen atom. R₂ can be an organic group that makes up the portion of the diisocyanate between the isocyanate groups. R₃ can be an organic group containing an acrylate or methacrylate functional group, which makes up the portion of the reactive diol between the hydroxyl groups. R₄ can be an ethanesulfonic acid group or a propanesulfonic acid group; and R₅ can be a cyclohexyl group. The term “organic group” can generally refer to carbon-containing groups with from 1 to 20 carbon atoms, and can be straight chained, branched, alicyclic, aromatic, etc. Organic groups can be substituted with O, S, P, N, B, etc. The R₄ and R₅ groups can be attached by reacting 3-(cyclohexylamino)-1-propanesulfonic acid (CAPS) or 2-(cyclohexylamino)ethanesulfonic acid (CHES) with the isocyanate group at the end of the polymer backbone. Additionally, n can be any integer, for example from 1 to 1,000.

As used herein, “polymerized monomer” is used to describe monomers in their polymerized state, e.g., after the monomers have bonded together to form a polymer chain. The names of monomers in their original state may be used even though it is understood that the monomers change in certain ways during polymerizing. For example, “polymerized diisocyanate and reactive diol” can refer to a polymer chain formed by polymerizing a diisocyanate and a reactive diol, even though the diisocyanate and reactive diol do not actually exist as separate molecules in the polymer. In the case of polymerized diisocyanates and reactive diols, a hydrogen atom of the hydroxyl group of the reactive diol is replaced by a bond between the oxygen atom of the hydroxyl group and the carbon atom of the isocyanate group of the diisocyanate. Thus, the reactive diol is no longer a reactive diol, but has become a portion of a polymer chain. However, “polymerized reactive diol” may still be used to refer to this portion of the polymer chain for the sake of convenience. The portions of the polymer chain formed from diisocyanates or diols can also be referred to as “diisocyanate units” and “diol units” for convenience.

In certain examples, the reactive diol polymerized in the polymer backbone can be selected from one or more of reactive diols (I)-(VI) set forth above. Reactive diols (I)-(VI) shown previously are exemplary only, as they can be modified and still function in accordance with examples of the present disclosure. As an example, reactive diol (III) includes a 4 carbon chain between two ether oxygens and reactive diol (IV) includes a 6 carbon chain between the same two ether oxygens. These structures could be modified to include a 3 carbon chain, a 5 carbon, chain, or a 7 carbon chain between these two ether oxygens. Alternatively, any of the structures that include an acrylate end group could be modified to a methacrylate end group, and vice versa (some of which are shown as both types, e.g., reactive diols (I) and (II) show both the acrylate and methacrylate type structure, whereas the other reactive diol structures (III)-(VI) show only one of the acrylate or methacrylate type). In further detail, other aromatic groups can be present other than that shown in reactive diol (VI). These are just a few examples of how these reactive diols could be modified beyond that which is shown above.

The reactive diol can include reactive functional groups that can participate in crosslinking. Acrylate and methacrylate groups can each participate in crosslinking as well through the double bonds in each of these functional groups. Thus, in some examples when the reactive polyurethane dispersion is heat-cured, for example, the double bonds in these groups may link together to form crosslinking between polymer strands. Some crosslinking may likewise occur with the fabric substrate without heat-curing, for example.

The diisocyanate polymerized in the polymer backbone is not particularly limited. Generally, the diisocyanate is a molecule having two isocyanate groups that can react with the hydroxyl groups of the reactive diol to form urethane linkages. In some examples, the diisocyanate used in the polymer backbone can be non-reactive. That is, the diisocyanate can be devoid of reactive functional groups other than the isocyanate groups. For example, the diisocyanate can be devoid of acrylate, methacrylate, acrylamide, allyl, styrene, and other functional groups that can participate in crosslinking. In alternate examples, the diisocyanate can include such functional groups.

In certain examples, the diisocyanate polymerized in the polymer backbone can be selected from the following diisocyanates:

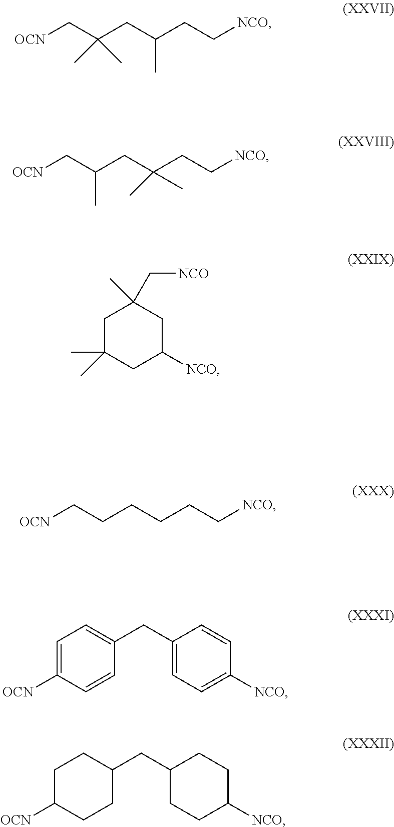

or a combination thereof.

Cap groups can be added to the polymer backbone by polymerizing a monofunctional monomer with the isocyanate groups at the terminal ends of the polymer backbone. In some examples of the reactive polyurethane dispersion described herein, two distinct cap groups can be included in the polymer strands. In certain examples, a polymer strand can have a first cap group at one end of the polymer backbone, and a second cap group at the other end of the polymer backbone. The first cap group can include an acrylate-containing monoalcohol, a methacrylate-containing monoalcohol, an allyl-containing monoalcohol, an allyl-containing monoamine, a styrene-containing monoalcohol, an acrylamide-containing monoalcohol, or a methacrylamide-containing monoalcohol reacted with an isocyanate group of the diisocyanate of the polymer backbone. The second cap group can be 3-(cyclohexylamino)-1-propanesulfonic acid (CAPS) or 2-(cyclohexylamino)ethanesulfonic acid (CHES) reacted with an isocyanate group of the diisocyanate.

In certain examples, the first cap group can be formed by polymerizing a monoalcohol, monoamine, monoalcohol diamine, monoalcohol monoamine, etc., shown previously as cap group structure (VII)-(XXV), or a combination thereof. In further examples, the reactive polyurethane dispersion can have a NCO/OH ratio of 1.2 to 10.

In another example, the reactive polyurethane dispersion can have a NCO/OH ratio of 2 to 3. As used herein, “NCO/OH ratio” refers to the mole ratio of NCO groups to OH groups in the monomers that react to form the polymer backbone. In still further examples, the reactive polyurethane dispersion can have a double bond density of 1 to 10. In other examples, the reactive polyurethane dispersion can have a double bond density of 2 to 10, 3 to 10, or 4 to 10. As used herein, “double bond density” refers to the number of millimoles of double bonds in 1 gram of the polyurethane polymer by dry weight.

The reactive polyurethane particles described herein can have an acid number from 20 to 100. In further examples, the reactive polyurethane dispersion can have an acid number from 25 mg KOH/g to 80 mg KOH/g, from 30 mg KOH/g to 60 mg KOH/g, or from 35 mg KOH/g to 50 mg KOH/g. As used herein, acid number refers to the number of milligrams of potassium hydroxide required to neutralize one gram of the polyurethane dispersion, by solid weight. The polyurethane particles can have a D50 particle size from 20 nm to 500 nm, from 75 nm to 350 nm, or from 100 nm to 300 nm, for example. The weight average molecular weight can be from 1,000 Mw to 200,000 Mw, from 2,000 Mw to 150,000 Mw, or from 3,000 Mw to 100,000 Mw, for example.

In various examples, the ink composition can include the reactive polyurethane in an amount from 0.5 wt % to 20 wt %, 2 wt % to 20 wt %, or from 2 wt % to 10 wt %, based on the dry solids weight of the polyurethane with respect to the total weight of the ink.

The pigment in the ink composition can include pigment colorant, for example. In some examples, the pigment can be present in an amount from 0.5 wt % to 12 wt %, from 0.5 wt % to 10 wt %, from 1 wt % to 8 wt %, or from 2 wt % to 6 wt % in the ink composition. The pigment in the ink composition can be self-dispersed with a polymer, oligomer, or small molecule; or can be dispersed with a separate dispersant. Furthermore, the pigment can be any of a number of pigments of any of a number of primary or secondary colors, or can be black or white, for example. More specifically, colors can include cyan, magenta, yellow, red, blue, violet, red, orange, green, etc. In one example, the ink composition can be a black ink with a carbon black pigment. In another example, the ink composition can be a cyan or green ink with a copper phthalocyanine pigment, e.g., Pigment Blue 15:0, Pigment Blue 15:1; Pigment Blue 15:3, Pigment Blue 15:4, Pigment Green 7, Pigment Green 36, etc. In another example, the ink composition can be a magenta ink with a quinacridone pigment or a co-crystal of quinacridone pigments. Example quinacridone pigments that can be utilized can include PR122, PR192, PR202, PR206, PR207, PR209, PO48, PO49, PV19, PV42, or the like. These pigments tend to be magenta, red, orange, violet, or other similar colors. In one example, the quinacridone pigment can be PR122, PR202, PV19, or a combination thereof. In another example, the ink composition can be a yellow ink with an azo pigment, e.g., PY74 and PY155. Other examples of pigments include the following, which are available from BASF Corp.: PALIOGEN® Orange, HELIOGEN® Blue L 6901F, HELIOGEN® Blue NBD 7010, HELIOGEN® Blue K 7090, HELIOGEN® Blue L 7101F, PALIOGEN® Blue L 6470, HELIOGEN® Green K 8683, HELIOGEN® Green L 9140, CHROMOPHTAL® Yellow 3G, CHROMOPHTAL® Yellow GR, CHROMOPHTAL® Yellow 8G, IGRAZIN® Yellow SGT, and IGRALITE® Rubine 4BL. The following pigments are available from Degussa Corp.: Color Black FWI, Color Black FW2, Color Black FW2V, Color Black 18, Color Black, FW200, Color Black 5150, Color Black S160, and Color Black 5170. The following black pigments are available from Cabot Corp.: REGAL® 400R, REGAL® 330R, REGAL® 660R, MOGUL® L, BLACK PEARLS® L, MONARCH® 1400, MONARCH® 1300, MONARCH® 1100, MONARCH® 1000, MONARCH® 900, MONARCH® 880, MONARCH® 800, and MONARCH® 700. The following pigments are available from Orion Engineered Carbons GMBH: PRINTEX® U, PRINTEX® V, PRINTEX® 140U, PRINTEX® 140V, PRINTEX® 35, Color Black FW 200, Color Black FW 2, Color Black FW 2V, Color Black FW 1, Color Black FW 18, Color Black S 160, Color Black S 170, Special Black 6, Special Black 5, Special Black 4A, and Special Black 4. The following pigment is available from DuPont: TI-PURE® R-101. The following pigments are available from Heubach: MONASTRAL® Magenta, MONASTRAL® Scarlet, MONASTRAL® Violet R, MONASTRAL® Red B, and MONASTRAL® Violet Maroon B. The following pigments are available from Clariant: DALAMAR® Yellow YT-858-D, Permanent Yellow GR, Permanent Yellow G, Permanent Yellow DHG, Permanent Yellow NCG-71, Permanent Yellow GG, Hansa Yellow RA, Hansa Brilliant Yellow 5GX-02, Hansa Yellow-X, NOVOPERM® Yellow HR, NOVOPERM® Yellow FGL, Hansa Brilliant Yellow 10GX, Permanent Yellow G3R-01, HOSTAPERM® Yellow H4G, HOSTAPERM® Yellow H3G, HOSTAPERM® Orange GR, HOSTAPERM® Scarlet GO, and Permanent Rubine F6B. The following pigments are available from Sun Chemical: QUINDO® Magenta, INDOFAST® Brilliant Scarlet, QUINDO® Red R6700, QUINDO® Red R6713, INDOFAST® Violet, L74-1357 Yellow, L75-1331 Yellow, L75-2577 Yellow, and LHD9303 Black. The following pigments are available from Birla Carbon: RAVEN® 7000, RAVEN® 5750, RAVEN® 5250, RAVEN® 5000 Ultra® II, RAVEN® 2000, RAVEN® 1500, RAVEN® 1250, RAVEN® 1200, RAVEN® 1190 Ultra®. RAVEN® 1170, RAVEN® 1255, RAVEN® 1080, and RAVEN® 1060. The following pigments are available from Mitsubishi Chemical Corp.: No. 25, No. 33, No. 40, No. 47, No. 52, No. 900, No. 2300, MCF-88, MA600, MA7, MA8, and MA100. The colorant may be a white pigment, such as titanium dioxide, or other inorganic pigments such as zinc oxide and iron oxide.

Specific other examples of a cyan color pigment may include C.I. Pigment Blue-1, -2, -3, -15, -15:1, -15:2, -15:3, -15:4, -16, -22, and -60; magenta color pigment may include C.I. Pigment Red-5, -7, -12, -48, -48:1, -57, -112, -122, -123, -146, -168, -177, -184, -202, and C.I. Pigment Violet-19; yellow pigment may include C.I. Pigment Yellow-1, -2, -3, -12, -13, -14, -16, -17, -73, -74, -75, -83, -93, -95, -97, -98, -114, -128, -129, -138, -151, -154, and -180. Black pigment may include carbon black pigment or organic black pigment such as aniline black, e.g., C.I. Pigment Black 1. While several examples have been given herein, it is to be understood that any other pigment can be used that is useful in color modification, or dye may even be used in addition to the pigment.

Furthermore, pigments and dispersants are described separately herein, but there are pigments that are commercially available which include both the pigment and a dispersant suitable for ink composition formulation. Specific examples of pigment dispersions that can be used, which include both pigment solids and dispersant are provided by example, as follows: HPC-K048 carbon black dispersion from DIC Corporation (Japan), HSKBPG-11-CF carbon black dispersion from Dom Pedro (USA), HPC-0070 cyan pigment dispersion from DIC, CABOJET® 250C cyan pigment dispersion from Cabot Corporation (USA), 17-SE-126 cyan pigment dispersion from Dom Pedro, HPF-M046 magenta pigment dispersion from DIC, CABOJET® 265M magenta pigment dispersion from Cabot, HPJ-Y001 yellow pigment dispersion from DIC, 16-SE-96 yellow pigment dispersion from Dom Pedro, or Emacol SF Yellow AE2060F yellow pigment dispersion from Sanyo (Japan).

Thus, the pigment(s) can be dispersed by a dispersant that is adsorbed or ionically attracted to a surface of the pigment, or can be covalently attached to a surface of the pigment as a self-dispersed pigment. In one example, the dispersant can be an acrylic dispersant, such as a styrene (meth)acrylate dispersant, or other dispersant suitable for keeping the pigment suspended in the liquid vehicle. In one example, the styrene (meth)acrylate dispersant can be used, as it can promote 7-stacking between the aromatic ring of the dispersant and various types of pigments. In one example, the styrene (meth)acrylate dispersant can have a weight average molecular weight from 4,000 Mw to 30,000 Mw. In another example, the styrene-acrylic dispersant can have a weight average molecular weight of 8,000 Mw to 28,000 Mw, from 12,000 Mw to 25,000 Mw, from 15,000 Mw to 25,000 Mw, from 15,000 Mw to 20,000 Mw, or about 17,000 Mw. Regarding the acid number, the styrene (meth)acrylate dispersant can have an acid number from 100 to 350, from 120 to 350, from 150 to 300, from 180 to 250, for example. Example commercially available styrene-acrylic dispersants can include Joncryl® 671, Joncryl® 71, Joncryl® 96, Joncryl® 680, Joncryl® 683, Joncryl® 678, Joncryl® 690, Joncryl® 296, Joncryl® 671, Joncryl® 696 or Joncryl® ECO 675 (all available from BASF Corp., Germany).

The ink composition can, in some examples, also include a photo-initiator. In examples with no added input of heat and/or UV energy, the addition of the photo-initiator can still provide enhanced durability to the ink composition when included in the ink composition, particularly with fabric substrates that are not cotton-based, compared to inks that do not include the photo-initiator. For example, the photo-initiator may be present in the ink composition in an amount ranging from 0.1 wt % to 10 wt % based on a total wt % of the ink composition. In other examples, the photo-initiator can be present in an amount from 0.1 wt % to 1 wt %. In one example, a water soluble photo-initiator can include a trimethylbenzoylphenylphosphinic acid monovalent salt (e.g., TPA metal salt such as Na salt) having the following formula:

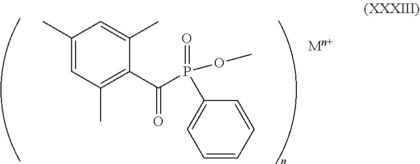

where n is any integer from 1 to 5 and Mⁿ⁺ is a metal with a valence from 1 to 5, and n can be coordinated with the valency of Mⁿ⁺. Examples of suitable metals include Li, Na, K, Cs, Rb, Be, Mg, Ca, Ba, Al, Ge, Sn, Pb, As, and Sb. In some examples, the water soluble photo-initiator may have a water solubility from 0.1 wt % to 20 wt %, from 0.5 wt % to 20 wt %, or from 1 wt % to 20 wt %, for example.

The ink compositions of the present disclosure can, in some examples, include a sensitizer, either with or without the presence of a photo-initiator. A sensitizer can act, in some instances, like an energy absorber that may absorb energy and convert that energy to heat, for example. However, in examples with no additional curing steps such as the application of heat and/or UV energy, the addition of the sensitizer can still provide enhanced durability to the ink composition when included in the ink composition, particularly with fabric substrates that are not cotton-based, compared to inks that do not include the sensitizer. When present, the sensitizer may be present in an amount of 0.1 wt % to 10 wt % of the ink composition. In other examples, the sensitizer can be present in amount of 0.1 wt % to 1 wt %. In some examples, the sensitizer may be a water soluble polymeric sensitizer that includes a functionalized anthrone moiety, a polyether chain, and an amide linkage or an ether linkage attaching one end of the polyether chain to the functionalized anthrone moiety. As used herein, “functionalized anthrone moiety” refers to a moiety having the chemical structure of an anthrone molecule, in which one or more carbon atoms may be optionally substituted with a sulphur atom, an oxygen atom, or a nitrogen atom, and in which one or more hydrogen atoms may be optionally substituted with a functional group. In one example, the anthrone moiety may be a thioxanthrenone moiety. In a further example, the polymeric sensitizer can have the following formula:

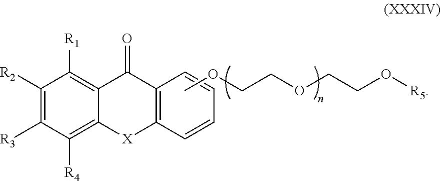

where R₁, R₂, R₃, R₄, and R₅ can be independently selected from the group of a hydrogen atom, a substituted or unsubstituted alkyl group, a substituted or unsubstituted allyl group, a substituted or unsubstituted alkene or alkenyl group, a substituted or unsubstituted aryl group, a substituted or unsubstituted aralkyl group, a halogen atom, —NO₂, —O—R_{d}, —CO—R_{d}, —CO—O—R_{d}, —O—CO—R_{d}, —CO—NR_{d}Rₑ, —NR_{d}Rₑ, —NR_{d}—CO—Rₑ, —NR_{d}—CO—O—Rₑ, —NR_{d}—CO—NRₑR_{f}, —SR_{d}, —SO—R_{d}, —SO₂—R_{d}, —SO₂—O—R_{d}, —SO₂NR_{d}Rₑ, or a perfluoroalkyl group. R_{d}, Rₑ, and R_{f} are each independently selected from the group consisting of a hydrogen atom, a substituted or unsubstituted alkyl group, a substituted or unsubstituted allyl group, a substituted or unsubstituted alkene or alkenyl group, a substituted or unsubstituted aryl group, and a substituted or unsubstituted aralkyl group. Some examples of suitable alkyl groups include methyl, ethyl, propyl, isopropyl, butyl, isobutyl, pentyl, hexyl, etc. One example of a suitable alkene group is an ethylene group. Some examples of suitable aryl groups include phenyl, phenylmethyl, etc. In the formula above, X can be O, S, or NH and the polyether chain can have n number of repeating monomer units, where n ranges from 1 to 200.

In addition to the pigment, the polyurethane, and other components that may also be included, e.g., sensitizer and/or photo-initiator, the ink compositions described herein can also include an aqueous liquid vehicle to carry and provide jettability to the ink compositions, for example. In one example, the liquid vehicle can include water and an organic co-solvent. In a further example, the organic co-solvent can be present in an amount from 4 wt % to 49 wt %, or from 8 wt % to 25 wt % with respect to the total weight of the ink. In a still further example, the organic co-solvent can be present in an amount from 10 wt % to 15 wt %. In a particular example, the organic co-solvent can be 1,2-butanediol. In other examples, the organic co-solvent can include ethylene glycol, diethylene glycol, triethylene glycol, propylene glycol, dipropylene glycol, tri propylene glycol, 1,2-propanediol, 1,3-propanediol, 1,2-butanediol, 1,3-butanediol, 1,4-butanediol, 2,3-butanediol, 2-methyl-1,2-propanediol, 1,5-pentanediol, 2-methyl-2,3-butanediol, 1,6-hexanediol, 1,2-hexanediol, 2,5-hexanediol, 2-methyl-2,4-pentanediol, 2,3-dimethyl-2,3-butanediol, 2-ethyl-hexanediol, 1,2-octanediol, 1,2-decanediol, 2,2,4-trimethylpentanediol, 2-butyl-2-ethyl-1,3-propanediol, 2,2-diethyl-1,3-propanediol, glycerin, trimethylolpropane, pentaerythritol, or the like.

In certain examples, the ink composition can include a surfactant or a mixture of surfactants in a total amount from 0.05 wt % to 15 wt %, from 0.1 wt % to 10 wt %, from 0.3 wt % to 8 wt %, or from 0.5 wt % to 1.5 wt % with respect to the total weight of the ink. Suitable surfactants can include anionic, cationic, amphoteric and nonionic surfactants. Commercially-available surfactants or dispersants include the TAMOL™ series from Dow Chemical Co., nonyl and octyl phenol ethoxylates from Dow Chemical Co. (e.g., TRITON™ X-45, TRITON™ X-100, TRITON™ X-114, TRITON™ X-165, TRITON™ X-305 and TRITON™ X-405) and other suppliers (e.g., the T-DET™ N series from Harcros Chemicals), alkyl phenol ethoxylate (APE) replacements from Dow Chemical Co., Elementis Specialties, and others, various members of the SURFYNOL® series from Air Products and Chemicals, (e.g., SURFYNOL® 104, SURFYNOL® 104A, SURFYNOL® 104BC, SURFYNOL® 104DPM, SURFYNOL® 104E, SURFYNOL® 104H, SURFYNOL® 104PA, SURFYNOL® 104PG50, SURFYNOL® 104S, SURFYNOL® 2502, SURFYNOL® 420, SURFYNOL® 440, SURFYNOL® 465, SURFYNOL® 485. SURFYNOL® 485W, SURFYNOL® 82, SURFYNOL® CT-211, SURFYNOL® CT-221, SURFYNOL® OP-340, SURFYNOL® PSA204, SURFYNOL® PSA216, SURFYNOL® PSA336, SURFYNOL® SE and SURFYNOL® SE-F), Capstone® FS-35 from DuPont, various fluorocarbon surfactants from 3M, E.I. DuPont, and other suppliers, or phosphate esters from Ashland, Rhodia and other suppliers.

Various other additives can be included to provide desirable printability, shelf-life, image quality, etc., properties to the ink composition. Examples of these additives are those added to inhibit the growth of harmful microorganisms. These additives may be biocides, fungicides, or other microbial agents. Examples of suitable microbial agents include, but are not limited to, NUOSEPT® (Nudex, Inc.), UCARCIDE™ (Union carbide Corp.), VANCIDE® (R.T. Vanderbilt Co.), PROXEL® (ICI America), or a combination thereof.

Sequestering agents, such as EDTA (ethylene diamine tetra acetic acid), may be included to eliminate the deleterious effects of heavy metal impurities, and/or buffer solutions may be used to control the pH of the ink. From 0.01 wt % to 2 wt %, for example, can be used if present. Viscosity modifiers and buffers may also be present, as well as other additives to modify properties of the ink as desired. Such additives can be present at from 0.01 wt % to 20 wt % if present.

Anti-kogation agents can also be included in the ink composition. In some examples, anti-kogation agents can be included in an amount of 0.1 wt % to 10 wt % with respect to the total weight of the ink. In other examples, the anti-kogation agents can be included in an amount of 0.1 wt % to 3 wt %. Examples of anti-kogation agents include surfactants of the Crodafos® family available from Croda Inc. (Great Britain), such as Crodafos®N3A, Crodafos®N3E, Crodafos®N10A, Crodafos® HCE and Crodafos® SG. Other examples include Arlatone® Map 950 available from Croda Inc.; Monofax® 831, Monofax®1214 available from Mona Industries; Monalube® 215 and Atlox® DP13/6 available from Croda Inc.; and Liponic® EG-1 (LEG-1) available from Lipo Chemicals (USA).

The textile printing systems and methods described herein can be suitable for printing on many types of textiles, such as cotton fibers, including treated and untreated cotton substrates, polyester substrates, nylons, blended substrates thereof, etc. Example natural fiber fabrics that can be used include treated or untreated natural fabric textile substrates, e.g., wool, cotton, silk, linen, jute, flax, hemp, rayon fibers, thermoplastic aliphatic polymeric fibers derived from renewable resources such as cornstarch, tapioca products, or sugarcanes, etc. Example synthetic fibers that can be used include polymeric fibers such as nylon fibers (also referred to as polyamide fibers), polyvinyl chloride (PVC) fibers, PVC-free fibers made of polyester, polyamide, polyimide, polyacrylic, polypropylene, polyethylene, polyurethane, polystyrene, polyaramid, e.g., Kevlar® (E. I. du Pont de Nemours Company, USA), polytetrafluoroethylene, fiberglass, polytrimethylene, polycarbonate, polyethylene terephthalate, polyester terephthalate, polybutylene terephthalate, or a combination thereof. In some examples, the fiber can be a modified fiber from the above-listed polymers. The term “modified fiber” refers to one or both of the polymeric fiber and the fabric as a whole having undergone a chemical or physical process such as, but not limited to, copolymerization with monomers of other polymers, a chemical grafting reaction to contact a chemical functional group with one or both of the polymeric fiber and a surface of the fabric, a plasma treatment, a solvent treatment, acid etching, or a biological treatment, an enzyme treatment, or antimicrobial treatment to prevent biological degradation.

As mentioned, in some examples, the fabric substrate can include natural fiber and synthetic fiber, e.g., cotton/polyester blend. The amount of each fiber type can vary. For example, the amount of the natural fiber can vary from about 5 wt % to about 95 wt % and the amount of synthetic fiber can range from about 5 wt % to 95 wt %. In yet another example, the amount of the natural fiber can vary from about 10 wt % to 80 wt % and the synthetic fiber can be present from about 20 wt % to about 90 wt %. In other examples, the amount of the natural fiber can be about 10 wt % to 90 wt % and the amount of synthetic fiber can also be about 10 wt % to about 90 wt %. Likewise, the ratio of natural fiber to synthetic fiber in the fabric substrate can vary. For example, the ratio of natural fiber to synthetic fiber can be 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, or vice versa.

The fabric substrate can be in one of many different forms, including, for example, a textile, a cloth, a fabric material, fabric clothing, or other fabric product suitable for applying ink, and the fabric substrate can have any of a number of fabric structures, including structures that can have warp and weft, and/or can be woven, non-woven, knitted, tufted, crocheted, knotted, and/or pressured, for example. The terms “warp” as used herein, refers to lengthwise or longitudinal yarns on a loom, while “weft” refers to crosswise or transverse yarns on a loom.

It is notable that the term “fabric substrate” or “fabric media substrate” does not include materials such as any paper (even though paper can include multiple types of natural and synthetic fibers or mixtures of both types of fibers). Fabric substrates can include textiles in filament form, textiles in the form of fabric material, or textiles in the form of fabric that has been crafted into a finished article, e.g., clothing, blankets, tablecloths, napkins, towels, bedding material, curtains, carpet, handbags, shoes, banners, signs, flags, etc. In some examples, the fabric substrate can have a woven, knitted, non-woven, or tufted fabric structure. In one example, the fabric substrate can be a woven fabric where warp yarns and weft yarns can be mutually positioned at an angle of about 90°. This woven fabric can include but is not limited to, fabric with a plain weave structure, fabric with a twill weave structure where the twill weave produces diagonal lines on a face of the fabric, or a satin weave. In another example, the fabric substrate can be a knitted fabric with a loop structure. The loop structure can be a warp-knit fabric, a weft-knit fabric, or a combination thereof. A warp-knit fabric refers to every loop in a fabric structure that can be formed from a separate yarn mainly introduced in a longitudinal fabric direction. A weft-knit fabric refers to loops of one row of fabric that can be formed from the same yarn. In a further example, the fabric substrate can be a non-woven fabric. For example, the non-woven fabric can be a flexible fabric that can include a plurality of fibers or filaments that are one or both bonded together and interlocked together by a chemical treatment process, e.g., a solvent treatment, a mechanical treatment process, e.g., embossing, a thermal treatment process, or a combination of multiple processes.

The fabric substrate can have a basis weight ranging from 10 grams per square meter (gsm) to 500 gsm. In another example, the fabric substrate can have a basis weight ranging from 50 gsm to 400 gsm. In other examples, the fabric substrate can have a basis weight ranging from 100 gsm to 300 gsm, from 75 gsm to 250 gsm, from 125 gsm to 300 gsm, or from 150 gsm to 350 gsm.

In addition, the fabric substrate can contain additives including, but not limited to, colorant (e.g., pigments, dyes, and/or tints), antistatic agents, brightening agents, nucleating agents, antioxidants, UV stabilizers, and/or fillers and lubricants, for example. Alternatively, the fabric substrate may be pre-treated in a solution containing the substances listed above before applying other treatments or coating layers.

Regardless of the substrate, whether natural, synthetic, blend thereof, treated, untreated, etc., the fabric substrates printed with the ink composition of the present disclosure can provide acceptable optical density (OD) and/or washfastness properties. The term “washfastness” can be defined as the OD that is retained or delta E (ΔE) after a specified number of standard washing machine cycles (1 cycle, 2 cycles, 3 cycles, 4 cycles, 5 cycles, etc.) using warm water and a standard clothing detergent (e.g., Tide® available from Proctor and Gamble, Cincinnati, Ohio, USA). By measuring OD and/or L*a*b* both before and after washing, ΔOD and ΔE value can be determined, which can be a quantitative way of expressing the difference between the OD and/or L*a*b*prior to and after undergoing the washing cycles. Thus, the lower the ΔOD and ΔE values, the better. In further detail, ΔE is a single number that represents the “distance” between two colors, which in accordance with the present disclosure, is the color (or black) prior to washing and the modified color (or modified black) after washing.

Colors, for example, can be expressed as CIELAB values. It is noted that color differences may not be symmetrical going in both directions (pre-washing to post washing vs. post-washing to pre-washing). Using the CIE 1976 definition, the color difference can be measured and the ΔE value calculated based on subtracting the pre-washing color values of L*, a*, and b* from the post-washing color values of L*, a*, and b*. Those values can then be squared, and then a square root of the sum can be determined to arrive at the ΔE value. The 1976 standard can be referred to herein as “ΔE_{CIE}.” The CIE definition was modified in 1994 to address some perceptual non-uniformities, retaining the L*a*b* color space, but modified to define the L*a*b* color space with differences in lightness (L*), chroma (C*), and hue (h*) calculated from L*a*b* coordinates. Then in 2000, the CIEDE standard was established to further resolve the perceptual non-uniformities by adding five corrections, namely i) hue rotation (R_{T}) to deal with the problematic blue region at hue angles of about 275°), ii) compensation for neutral colors or the primed values in the L*C*h differences, iii) compensation for lightness (SL), iv) compensation for chroma (Sc), and v) compensation for hue (S_{H}). The 2000 modification can be referred to herein as “ΔE₂₀₀₀.” In accordance with examples of the present disclosure, ΔE value can be determined using the CIE definition established in 1976, 1994, and 2000 to demonstrate washfastness. However, in the examples of the present disclosure, ΔE_{CIE} is used.

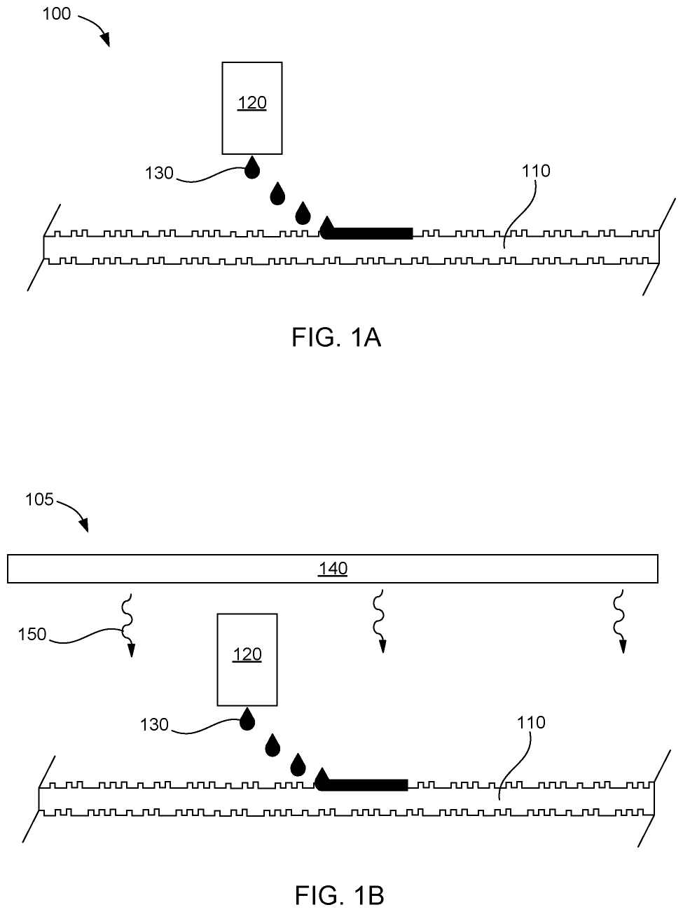

FIG. 1A shows an example textile printing system 100. The system includes a fabric substrate 110, an inkjet printhead 120 in fluid communication with a reservoir containing an ink composition 130 to eject an ink composition onto the fabric substrate. FIG. 1B shows an alternative textile printing system 105 example, which uses the application of heat 150 from a heat energy source 140 to assist with ink composition permanence on the fabric substrate. In FIG. 1B, the other elements are the same as that shown in FIG. 1A. If heat is used, it can be applied at from 120° C. to 220° C., from 140° C. to 200° C., or from 150° C. to 180° C., for example. If no heat is applied, then after printing, the printed fabric substrate can be air dried with ambient air or can be air dried with forced air, for example. The ink composition in these two examples include from 50 wt % to 95 wt % water, from 4 wt % to 49 wt % organic co-solvent, from 0.5 wt % to 12 wt % pigment that includes a dispersant associated with a surface thereof, and from 0.5 wt % to 20 wt % polyurethane particles. The polyurethane particles are of a polyurethane strand including a polyurethane backbone with a pendant reactive (meth)acrylate-containing diol group and terminal end cap groups. The terminal end cap groups in this example can be selected from a monoalcohol, a monoamine, an acrylate, a methacrylate, or a combination thereof.

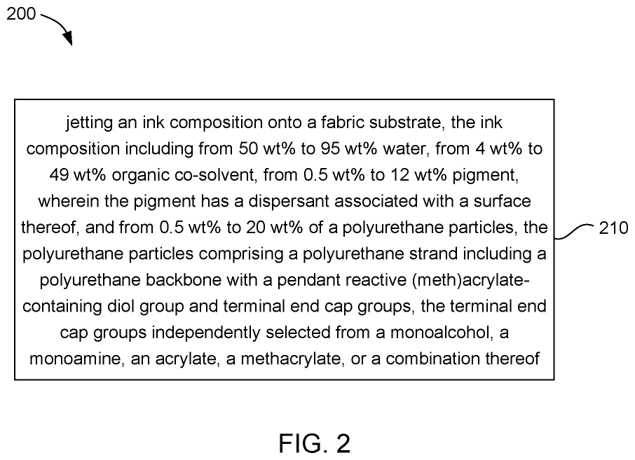

FIG. 2, on the other hand, shows a flow diagram of an example method 200 of textile printing that can include jetting 210 an ink composition onto a fabric substrate. The ink composition in this example includes from 50 wt % to 95 wt % water, from 4 wt % to 49 wt % organic co-solvent, from 0.5 wt % to 12 wt % pigment with a dispersant associated with a surface thereof, and from 0.5 wt % to 20 wt % of a polyurethane particles. The polyurethane particles include a polyurethane strand with a polyurethane backbone having a pendant reactive (meth)acrylate-containing diol group and terminal end cap groups, and the terminal end cap groups are independently selected from a monoalcohol, a monoamine, an acrylate, a methacrylate, or a combination thereof. This method can be carried out without a heat-curing and without a UV-curing step, for example, still resulting in good washfastness durability.

The systems and methods shown in FIGS. 1A, 1B, and 2 can include any of the details described herein with respect to the ink composition, the fabric substrate, etc.

It is noted that, as used in this specification and the appended claims, the singular forms “a,” “an,” and “the” include plural referents unless the content clearly dictates otherwise.

“D50” particle size is defined as the particle size at which about half of the particles are larger than the D50 particle size and about half of the other particles are smaller than the D50 particle size (by weight based on the metal particle content of the particulate build material). As used herein, particle size with respect to the polyurethane particles can be based on volume of the particle size normalized to a spherical shape for diameter measurement, for example. Particle size can be collected using a Zetasizer from Malvern Panalytical (United Kingdom), for example. Likewise, the “D95” is defined as the particle size at which about 5 wt % of the particles are larger than the D95 particle size and about 95 wt % of the remaining particles are smaller than the D95 particle size. Particle size information can also be determined and/or verified using a scanning electron microscope (SEM).

It is to be understood that this disclosure is not limited to the particular process steps and materials disclosed herein because such process steps and materials may vary somewhat. It is also to be understood that the terminology used herein is used for the purpose of describing particular examples only. The terms are not intended to be limiting because the scope of the present disclosure is intended to be limited only by the appended claims and equivalents thereof.

The term “acid value” or “acid number” refers to the mass of potassium hydroxide (KOH) in milligrams that can be used to neutralize one gram of substance (mg KOH/g), such as the polyurethane disclosed herein. This value can be determined, in one example, by dissolving or dispersing a known quantity of a material in organic solvent and then titrating with a solution of potassium hydroxide (KOH) of known concentration for measurement.

The term “(meth)acrylic” or “(meth)acrylate” refers to monomers, copolymerized monomers, functional moieties of a polymer, etc., include both examples of an acrylate or methacrylate (or a combination of both), or acrylic acid or methacrylic acid (or a combination of both), as if independently listed or enumerated. When referring to “acrylic” versus “acrylate,” for example, it is understood that it can be in the acid form or the salt form, which may typically merely be a function of pH.

As used herein, “liquid vehicle” or “ink vehicle” refers to a liquid fluid in which pigment and the reactive polyurethane, and in some instances a sensitizer and/or a photo-initiator, is dispersed and otherwise placed to form an ink composition. A wide variety of liquid vehicles may be used with the systems and methods of the present disclosure. Such liquid vehicles may include a mixture of a variety of different agents, including, water, organic co-solvents, surfactants, anti-kogation agents, buffers, biocides, sequestering agents, viscosity modifiers, surface-active agents, water, etc.

As used herein, “pigment” generally includes pigment colorants.

As used herein, “inkjetting,” “jetting,” or “ejecting” refers to ink compositions that are ejected from jetting architecture, such as inkjet architecture. Inkjet architecture can include thermal or piezo architecture. Additionally, such architecture can be configured to print varying drop sizes such as less than 10 nanograms (ng), less than 20 ng, less than 30 ng, less than 40 ng, less than 50 ng, etc. These upper limits can, in one example, also provide the upper limit of various ranges, where 1 ng or 2 ng can represent the lower end of the various range.

As used herein, the term “about” is used to provide flexibility to a numerical range endpoint by providing that a given value may be “a little above” or “a little below” the endpoint. The degree of flexibility of this term can be dictated by the particular variable and determined based on the associated description herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include individual numerical values or sub-ranges encompassed within that range as if each numerical value and sub-range is explicitly recited. As an illustration, a numerical range of “about 1 wt % to about 5 wt %” should be interpreted to include not only the explicitly recited values of about 1 wt % to about 5 wt %, but also include individual values and sub-ranges within the indicated range. Thus, included in this numerical range are individual values such as 2, 3.5, and 4 and sub-ranges such as from 1-3, from 2-4, and from 3-5, etc. This same principle applies to ranges reciting only one numerical value. Furthermore, such an interpretation should apply regardless of the breadth of the range or the characteristics being described.

### EXAMPLES

The following illustrates several examples of the present disclosure. However, it is to be understood that the following are only illustrative of the application of the principles of the present disclosure. Numerous modifications and alternative compositions, methods, and systems may be devised without departing from the spirit and scope of the present disclosure. The appended claims are intended to cover such modifications and arrangements.

### Example 1—Synthesis of Reactive Polyurethane 1 (PUD 1)

33.545 grams of bisphenol A diglycidyl ether diacrylate (BGDA—see compound I above), 0.335 gram of 4-methoxyphenol (MEHQ), 43.585 grams of 4,4′-methylene dicyclohexyl diisocyanate (H12MD1—see compound XXXII above), and 42 grams of acetone were mixed in a 500 ml of 4-neck round bottom flask. A mechanical stirrer with glass rod and Teflon blade was attached. A condenser was attached. The flask was immersed in a constant temperature bath at 60° C. The system was kept under drying tube. 3 drops of dibutyltin dilaurate (DBTDL) was added to initiate the polymerization. Polymerization was continued for 3 hours at 60° C. 0.5 gram samples were withdrawn for wt % isocyanate (NCO) titration to confirm the reaction. The measured NCO value was 10.35 wt %. Theoretical wt % NCO was 10.55%. 15.939 grams of N-hydroxylethyl acrylamide (HEAA CAS #7646-67-5 from Sigma Aldrich), 0.159 gram of MEHQ, and 19 grams of acetone were mixed in a beaker and added to the reactor over 30 sec. 9 grams of acetone was used to rinse off the residual monomers on the beaker and added to the reactor. The polymerization was continued 3 hours at 50° C. 0.5 gram of pre-polymer was withdrawn for final wt % NCO titration. The measured NCO value was 2.45%. The theoretical wt % NCO was 2.50%. The polymerization temperature was reduced to 40° C. 6.931 grams of taurine, 4.652 grams of 50 wt % sodium hydroxide (NaOH), and 34.653 grams of deionized water were mixed in a beaker until taurine was completely dissolved. Taurine solution was added to the pre-polymer solution at 40° C. with vigorous stirring over 1-3 minutes. The solution became viscous and slightly hazy. Stirring continued for 30 minutes at 40° C. The mixture became clear and viscous after 15-20 minutes at 40° C. 197.381 grams of deionized water was added to the polymer mixture in 4-neck round bottom flask over 1-3 minutes with good agitation to form PUD dispersion. The agitation was continued for 60 minutes at 40° C. The PUD dispersion was filtered through 400 mesh stainless sieve. Acetone was removed with rotorvap at 50° C. (add 2 drops, or 20 mg, or BYK-011 de-foaming agent, available from BYK-chemie, Gmbh, Germany). The final PUD dispersion was filtered through fiber glass filter paper. Particle size was measured by Malvern Zetasizer is 32.6 nm. Its pH was 7.5. Solid content was 29.08 wt %. This PUD showed a 0.47-unit pH drop after 1 week ASL.

### Example 2—Synthesis of Reactive Polyurethane 2 (PUD 2)

38.884 grams of bisphenol A diglycidyl ether diacrylate (BGDA) 0.389 gram of 4-methoxyphenol (MEHQ), 42.103 grams of 4,4′-methylene dicyclohexyl diisocyanate (H12MD1), and 42 grams of acetone were mixed in a 500 ml of 4-neck round bottom flask. A mechanical stirrer with glass rod and Teflon blade was attached. A condenser was attached. The flask was immersed in a constant temperature bath at 60° C. The system was kept under drying tube. 3 drops of dibutyltin dilaurate (DBTDL) was added to initiate the polymerization. Polymerization was continued for 3 hours at 60° C. 0.5 gram samples were withdrawn for wt % NCO titration to confirm the reaction. The measured NCO value was 7.6 wt %. Theoretical wt % NCO was 8.32 wt %. 12.318 grams of N-hydroxylethyl acrylamide (HEAA), 0.159 gram of MEHQ, and 19 grams of acetone were mixed in a beaker and added to the reactor over 30 sec. 9 grams of acetone was used to rinse off the residual monomers on the beaker and added to the reactor. The polymerization was continued 3 hours at 50° C. 0.5 gram of pre-polymer was withdrawn for final wt % NCO titration. The measured NCO value was 2.41 wt %. The theoretical wt % NCO was 2.41 wt %. The polymerization temperature was reduced to 40° C. 6.695 grams of taurine, 4.494 grams of 50 wt % NaOH, and 33.474 grams of deionized water were mixed in a beaker until taurine was completely dissolved. Taurine solution was added to the pre-polymer solution at 40° C. with vigorous stirring over 1-3 minutes. The solution became viscous and slightly hazy. Stirring continued for 30 minutes at 40° C. The mixture became clear and viscous after 15-20 minutes at 40° C. 194.649 grams of deionized water was added to the polymer mixture in 4-neck round bottom flask over 1-3 minutes with good agitation to form PUD dispersion. The agitation was continued for 60 minutes at 40° C. The PUD dispersion was filtered through 400 mesh stainless sieve. Acetone was removed with rotorvap at 50° C. (add 2 drops (20 mg) BYK-011 de-foaming agent If there is a lot of foaming). The final PUD dispersion was filtered through fiber glass filter paper. Particle size was measured by Malvern Zetasizer is 26.8 nm. Its pH was 6.0. Solid content was 30.04 wt %. This PUD showed a 0.13 unit pH drop after 1 week ASL.

### Example 3—Synthesis of Reactive Polyurethane 3 (PUD 3)

33.732 grams of bisphenol A diglycidyl ether diacrylate (BGDA), 0.337 gram of 4-methoxyphenol (MEHQ), 40.176 grams of 4,4′-methylene dicyclohexyl diisocyanate (H12MD1), 3.095 grams of isophorone diisocyanate (IPDI—see compound XXIX) and 42 grams of acetone were mixed in a 500 ml of 4-neck round bottom flask. A mechanical stirrer with glass rod and Teflon blade was attached. A condenser was attached. The flask was immersed in a constant temperature bath at 60° C. The system was kept under drying tube. 3 drops of dibutyltin dilaurate (DBTDL) was added to initiate the polymerization. Polymerization was continued for 3 hours at 60° C. 0.5 gram samples were withdrawn for wt % NCO titration to confirm the reaction. The measured NCO value was 10.32 wt %. Theoretical wt % NCO was 10.63 wt %. 16.028 grams of N-hydroxylethyl acrylamide (HEAA), 0.160 gram of 4-methoxyphenol (MEHQ), and 19 grams of acetone were mixed in a beaker and added to the reactor over 30 sec. 9 grams of acetone was used to rinse off the residual monomers on the beaker and added to the reactor. The polymerization was continued 3 hours at 50° C. 0.5 gram of pre-polymer was withdrawn for final wt % NCO titration. The measured NCO value was 2.49 wt %. The theoretical wt % NCO was 2.51 wt %. The polymerization temperature was reduced to 40° C. 6.969 grams of taurine, 4.678 grams of 50 wt % NaOH, and 34.846 grams of deionized water were mixed in a beaker until taurine was completely dissolved. Taurine solution was added to the pre-polymer solution at 40° C. with vigorous stirring over 1-3 minutes. The solution became viscous and slightly hazy. Stirring continued for 30 minutes at 40° C. The mixture became clear and viscous after 15-20 minutes at 40° C. 197.314 grams of deionized water was added to the polymer mixture in 4-neck round bottom flask over 1-3 minutes with good agitation to form PUD dispersion. The agitation was continued for 60 minutes at 40° C. The PUD dispersion was filtered through 400 mesh stainless sieve. Acetone was removed with rotorvap at 50° C. (add 2 drops (20 mg) BYK-011 de-foaming agent if there is a lot of foaming). The final PUD dispersion was filtered through fiber glass filter paper. Particle size was measured by Malvern Zetasizer is 25.5 nm. Its pH was 7.4. Solid content was 30.0 wt %. This PUD showed a 0.19-unit pH drop after 1 week ASL.

### Example 4—Synthesis of Reactive Polyurethane 4 with Ionic Stabilizing Sulfonic Acid Group (PUD 4)

22.288 grams of bisphenol A diglycidyl ether diacrylate (BGDA), 0.223 gram of 4-methoxyphenol (MEHQ), 36.199 grams of 4,4′-methylene dicyclohexyl diisocyanate (H12MD1) and 30 grams of acetone were mixed in a 500 ml of 4-neck round bottom flask. A mechanical stirrer with glass rod and Teflon blade was attached. A condenser was attached. The flask was immersed in a constant temperature bath at 60° C. The system was kept under drying tube. 3 drops of DBTDL was added to initiate the polymerization. Polymerization was continued for 3 hours at 60° C. 0.5 gram samples were withdrawn for wt % NCO titration to confirm the reaction. 26.244 grams of glycerol 1,3-dimethacrylate (HPBMA—see compound VII above), 0.262 gram of 4-methoxyphenol (MEHQ), and 19 grams of acetone were mixed in a beaker and added to the reactor over 30 sec. 9 grams of acetone was used to rinse off the residual monomers on the beaker and added to the reactor. The polymerization was continued 3 hours at 60° C. The polymerization temperature was reduced to 40° C. 15.269 grams of 3-(cyclohexylamino)-1-propanesulfonic acid (CAPS), 5.795 grams of 50 wt % NaOH, and 38.172 grams of deionized water were mixed in a beaker until CAPS was completely dissolved. The CAPS solution was added to the pre-polymer solution at 40° C. with vigorous stirring over 1-3 minutes. The solution became viscous and slightly hazy. Stirring continued for 30 minutes at 40° C. The mixture became clear and viscous after 15-20 minutes at 40° C. 186.374 grams of deionized water was added to the polymer mixture in 4-neck round bottom flask over 1-3 minutes with good agitation to form PUD dispersion. The agitation was continued for 60 minutes at 40° C. The PUD dispersion was filtered through 400 mesh stainless sieve. Acetone was removed with rotorvap at 50° C. (add 2 drops (20 mg) BYK-011 de-foaming agent if there is a lot of foaming). The final PUD dispersion was filtered through fiber glass filter paper. Particle size was measured by Malvern Zetasizer is 18.98 nm. Its pH was 7.5. Solid content was 28.21 wt %.

### Example 5—Synthesis of Reactive Polyurethane 5 with Ionic Stabilizing Sulfonic Acid Group (PUD 5)

22.506 grams of bisphenol A diglycidyl ether diacrylate (BGDA), 0.225 gram of 4-methoxyphenol (MEHQ), 36.553 grams of 4,4′-methylene dicyclohexyl diisocyanate (H12MD1) and 30 grams of acetone were mixed in a 500 ml of 4-neck round bottom flask. A mechanical stirrer with glass rod and Teflon blade was attached. A condenser was attached. The flask was immersed in a constant temperature bath at 60° C. The system was kept under drying tube. 3 drops of dibutyltin dilaurate (DBTDL) was added to initiate the polymerization. Polymerization was continued for 3 hours at 60° C. 0.5 gram samples were withdrawn for wt % NCO titration to confirm the reaction. 26.500 grams of glycerol 1,3-dimethacrylate (HPBMA), 0.265 gram of 4-methoxyphenol (MEHQ), and 19 grams of acetone were mixed in a beaker and added to the reactor over 30 sec. 9 grams of acetone was used to rinse off the residual monomers on the beaker and added to the reactor. The polymerization was continued 3 hours at 60° C. The polymerization temperature was reduced to 40° C. 14.441 grams of 2-(cyclohexylamino)ethansesulfonic acid (CHES), 5.852 grams of 50% NaOH, and 38.102 grams of deionized water was mixed in a beaker until CHES was completely dissolved. The CHES solution was added to the pre-polymer solution at 40° C. with vigorous stirring over 1-3 minutes. The solution became viscous and slightly hazy. Stirring continued for 30 minutes at 40° C. The mixture became clear and viscous after 15-20 minutes at 40° C. 187.6144 grams of deionized water was added to the polymer mixture in 4-neck round bottom flask over 1-3 minutes with good agitation to form PUD dispersion. The agitation was continued for 60 minutes at 40° C. The PUD dispersion was filtered through 400 mesh stainless sieve. Acetone was removed with rotorvap at 50° C. (add 2 drops (20 mg) BYK-011 de-foaming agent if there is a lot of foaming). The final PUD dispersion was filtered through fiber glass filter paper. Particle size was measured by Malvern Zetasizer is 21.93 nm. Its pH was 7.0. Solid content was 27.22 wt %.

### Example 6—Ink Compositions

Ink compositions were prepared using magenta pigment and the reactive polyurethane prepared in accordance with Example 5. PUD 5 was selected because it included a reactive sulfonic acid group associated with an end cap group, providing enhanced dispersability in aqueous ink compositions, as shown in Table 1 below:

TABLE 1
Ink Compositions

| Components | Type | Ink (wt %) |
|---|---|---|
| 1,2-Butanediol | Co-Solvent | 8 |
| PUD 5 | Reactive PUD | 5 |
| HPF-M046 | Magenta Pigment | 4 |
| M-TX-PEG-550 | Sensitizer | 0.85 |
| TPA Na | Photo-initiator | 0.5 |
| Crodafos ® N3A | Anti-Kogation | 0.5 |
| Capstone ® FS-35 | Surfactant | 0.3 |
| Water | Solvent | Balance |

1,2-Butanediol acts as a co-solvent to enhance decap performance of the ink compositions;
PUD 5 is a reactive polyurethane dispersion as prepared in accordance with Example 5;
HPF-M046 is a magenta pigment from a magenta pigment dispersion (available from DIC Corporation, China);
M-TX-PEG-550 is a mono-(2-oxythioxanthone) derivative of PEG 550 (supplied by Hangzhou Silong, China);
TPA Na is a (sodium) salt trimethylbenzoylphenylphosphinic acid, e.g., phenyl-(2,4,6-trimethylbenzoyl)phosphinate (supplied by Hangzhou Silong; China);
Crodafos® is an anti-kogation agent (available from Croda, Inc., Great Britain); and
Capstone® FS-35 is a surfactant (available from DuPont, USA).

As evident from Table 1, Ink 1 did not include a sensitizer or a photo-initiator, Ink 2 included an added sensitizer, and Ink 3 included both an added sensitizer and a photo-initiator.

### Example 7—Binder Fluid

A clear binder fluid was prepared using the reactive polyurethane prepared in accordance with Example 5. PUD 5 was selected because it included a reactive sulfonic acid group associated with an end cap group, providing enhanced dispersability in aqueous ink compositions, as shown in Table 1 below:

TABLE 2
Binder Fluid

| Components | Type | Binder (wt %) |
|---|---|---|
| 1,2-Butanediol | Co-Solvent | 12 |
| Tripropylene Glycol Methyl Ether | Co-solvent | 1.5 |
| (Dowanol ® TPM) | | |
| PUD 5 | Reactive PUD | 8 |
| HPF-M046 | Magenta Pigment | 4 |
| M-TX-PEG-550 | Sensitizer | 0.85 |
| TPA Na | Photo-initiator | 0.5 |
| Capstone ® FS-35 | Surfactant | 0.3 |
| Prefiltered Liquilube ™ LL405 | Wax | 1 |
| Wax | | |
| Acid Red 52 | Dye | 0.30% |
| Water | Solvent | Balance |

Dowanol® TPM is a tri propylene glycol methyl ether co-solvent (supplied by Dow, USA);

Liquilube™ is a polyethylene emulsion wax (supplied by Lubrizol, France); and

Acid Red 52 is a water-soluble dye added in a minor amount so that the otherwise clear binder fluid is visible.

### Example 8—Washfastness Durability of Magenta Ink Compositions

A magenta ink composition was prepared in accordance with Table 1 and a binder fluid was prepared in accordance with Table 2. Various print sample were prepared using an inkjet printer to print ink onto various fabric substrates, with or without binder fluid, at various drops per pixel (dpp) drop volumes. The printed fabric samples were prepared according to the following details: 12 ng drop weight; 3 dots per pixel (dpp) unless specified otherwise; 45° C. trickle warming (TW) temperature; 30V inkjet firing voltage; 0.25/0.6/0.6 printing drop files (PDF); 1000 micro-recirculation pumping pulses; and 100 feet per minute (fpm) print speed. After the printed fabric samples were prepared, the fabric substrates were exposed to a durability challenge, namely a washfastness challenge, e.g., five (5) washing machine cycles using warm water (40° C.) and a standard clothing detergent (e.g., Tide® available from Proctor and Gamble, Cincinnati, Ohio, USA), with air drying between wash cycles. Before and after measurements were obtained related to optical density (OD) and the CIELAB color space values (L*a*b*).

The data collected is provided in Tables 3-7 below, as follows:

TABLE 3
Optical Density (OD) Durability of Magenta Ink
Compositions On Untreated Gray Cotton Fabric

| | OD | | |
|---|---|---|---|
| | Ink Dried Then | Binder Applied | Ink Only |
| | Binder Applied | While Ink Wet | (no binder) |
| Before Wash | 1.08 | 1.08 | 1.00 |
| After 1 Wash | 1.03 | 1.01 | 0.99 |
| After 2 Washes | 1.00 | 0.99 | 0.97 |
| After 3 Washes | 0.98 | 0.96 | 0.93 |
| After 4 Washes | 0.97 | 0.95 | 0.92 |
| After 5 Washes | 0.96 | 0.92 | 0.92 |

TABLE 4
Delta E_{CIE} (ΔE_{CIE}) Durability of Magenta
Ink Compositions On Coated Cotton Fabric

| | ΔE_{CIE} | | |
|---|---|---|---|
| | Ink Dried Then | Binder Applied | Ink Only |
| | Binder Applied | While Ink Wet | (no binder) |
| After 1 Wash | 3.70 | 3.97 | 1.963 |
| After 2 Washes | 4.74 | 5.09 | 2.28 |
| After 3 Washes | 5.35 | 7.22 | 3.61 |
| After 4 Washes | 6.43 | 6.91 | 4.12 |
| After 5 Washes | 6.36 | 8.77 | 4.48 |

ΔE_{CIE} uses the 1976 standard, as modified in 1994, and in summary, uses a single number to represent the “distance” between two colors. Thus, after washing and some color-fade, a low ΔE_{CIE} value tends to indicate more washfastness durability, for example.

TABLE 5
OD Durability of Magenta Ink Compositions Without
Binder Fluid (Ink Only) on Coated Cotton Fabric

| | Drop Weight (12 ng) at 1, 2, | | |
|---|---|---|---|
| | or 3 Drops Per Pixel (dpp) | | |
| | 1 dpp | 2 dpp | 3 dpp |
| Before Wash | 0.758 | 1.2965 | 1.58 |
| After 1 Wash | 0.748 | 1.267 | 1.5965 |
| After 2 Washes | 0.7365 | 1.258 | 1.579 |
| After 3 Washes | 0.7275 | 1.254 | 1.571 |
| After 4 Washes | 0.7155 | 1.2125 | 1.561 |
| After 5 Washes | 0.7155 | 1.2085 | 1.5315 |

TABLE 6
OD Durability of Magenta Ink Compositions Without Binder
Fluid (Ink Only) on Jacquard Cotton Fabric Substrate

| | Drop Weight (12 ng) at 1, 2, | | |
|---|---|---|---|
| | or 3 Drops Per Pixel (dpp) | | |
| | 1 dpp | 2 dpp | 3 dpp |
| Before Wash | 0.9445 | 1.098 | 1.1285 |
| After 1 Wash | 0.9605 | 1.109 | 1.142 |
| After 2 Washes | 0.9505 | 1.0955 | 1.1205 |
| After 3 Washes | 0.9255 | 1.069 | 1.1136 |
| After 4 Washes | 0.9175 | 1.0545 | 1.08 |
| After 5 Washes | 0.8725 | 1.0375 | 1.072 |

TABLE 7
OD Durability of Magenta Ink Compositions With Heat Treatment
and Without Binder Fluid (Ink Only) on Gray 100% Cotton,
Nylon, Silk, and 50/50 Polyester/Cotton Blend

| | Initial OD | OD5 | | |
|---|---|---|---|---|
| Heat/Pressure | (before | (after 5 | % | |
| (150° C./5 ATM) | wash) | washes) | ΔOD | ΔE_{CIE} |
| Gray 100% Cotton | 1.0375 | 0.923 | −0.1145 | 6.160 |
| Nylon | 1.100 | 1.031 | −0.070 | 4.624 |
| Silk | 1.162 | 0.966 | −0.196 | 7.639 |
| 50/50 Polyester | 1.077 | 0.931 | −0.146 | 7.154 |
| Cotton Blend | | | | |

As can be seen from Tables 3-7 above, the reactive polyurethane (PUD 5) evaluated in ink compositions both without heat curing and with heat curing provided good durability results, in many instances outperforming the ink compositions printed on fabric and then over-coated with a binder fluid.

While the present technology has been described with reference to certain examples, various modifications, changes, omissions, and substitutions can be made without departing from the disclosure. It is intended, therefore, that the disclosure be limited by the scope of the following claims.

What is claimed is:

1. A textile printing system, comprising:
an ink composition, comprising:
from 50 wt % to 95 wt % water,
from 4 wt % to 49 wt % organic co-solvent,
from 0.5 wt % to 12 wt % pigment, wherein the pigment has a dispersant associated with a surface thereof, and
from 0.5 wt % to 20 wt % of a polyurethane particles, the polyurethane particles comprising a polyurethane strand including a polyurethane backbone with a pendant reactive (meth)acrylate-containing diol group and terminal end cap groups, the terminal end cap groups independently selected from a monoalcohol, a monoamine, an acrylate, a methacrylate, or a combination thereof; and
a fabric substrate.

2. The textile printing system of claim 1, wherein the polyurethane strand further comprises a carboxylated- or sulfonated-stabilization group appended thereto.

3. The textile printing system of claim 2, wherein the carboxylated- or sulfonated-stabilization group includes 3-(cyclohexylamino)-1-propanesulfonic acid attached to the polyurethane strand through a nitrogen, 2-(cyclohexylamino)ethanesulfonic acid attached to the polyurethane strand through a nitrogen, or both.

4. The textile printing system of claim 1, wherein the pendant reactive (meth)acrylate-containing diol groups are attached to the polyurethane strand or pre-polymer thereof by reaction of the polyurethane strand or pre-polymer thereof with: 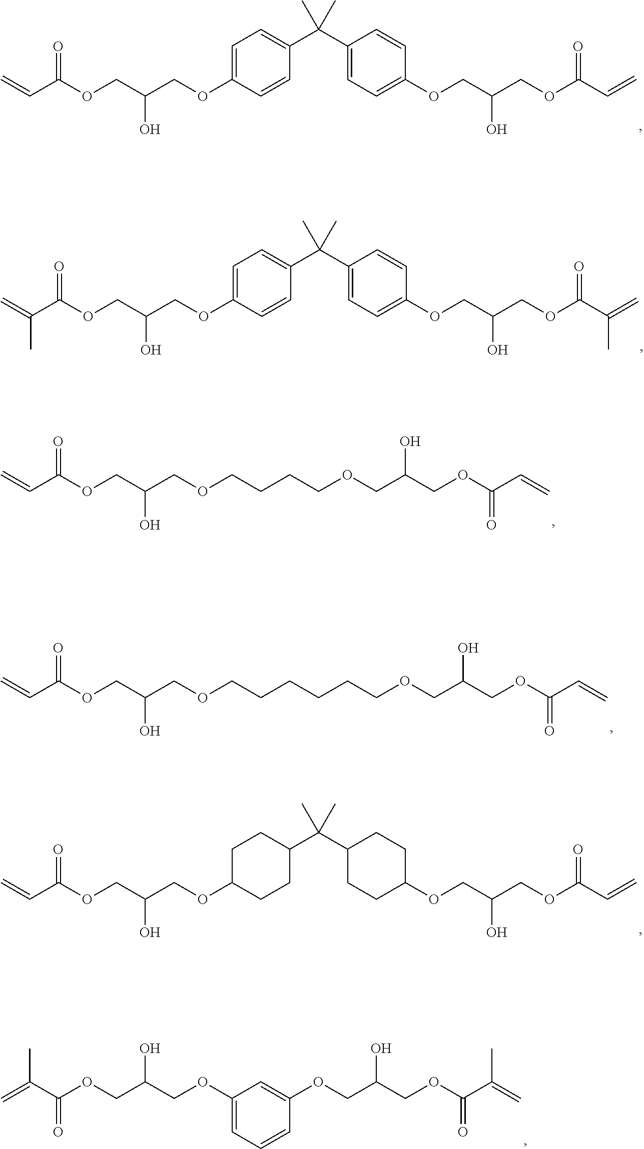
or a combination thereof.

5. The textile printing system of claim 1, wherein one or both terminal end cap groups includes an acrylate-containing monoalcohol, a methacrylate-containing monoalcohol, an allyl-containing monoalcohol, an allyl-containing monoamine, a styrene-containing monoalcohol, an acrylamide-containing monoalcohol, or a methacrylamide-containing monoalcohol.

6. The textile printing system of claim 1, wherein one or both terminal end cap groups includes a monoalcohol or monoamine at ends of the polyurethane strand and are attached by reaction of the polyurethane strand or pre-polymer thereof with: 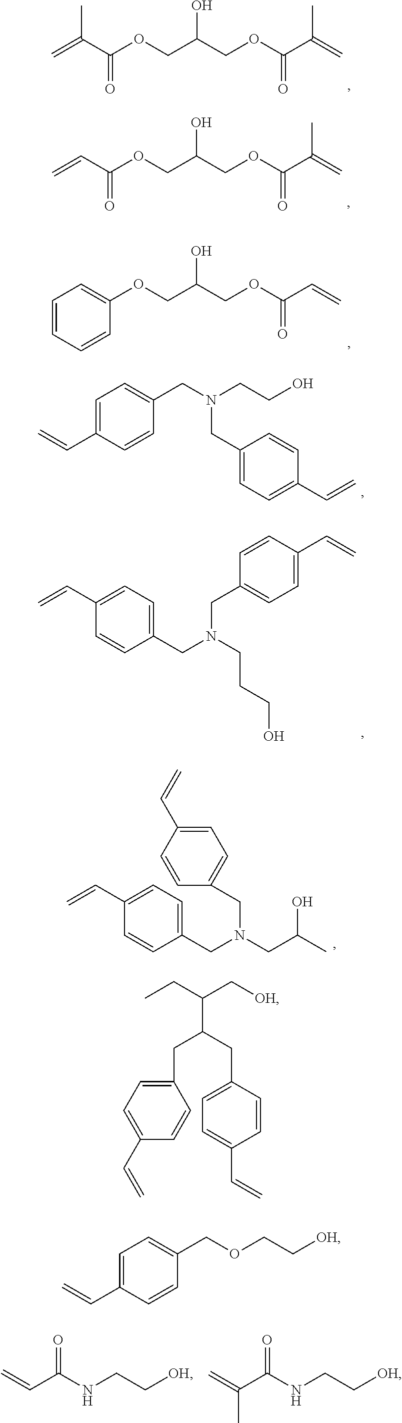 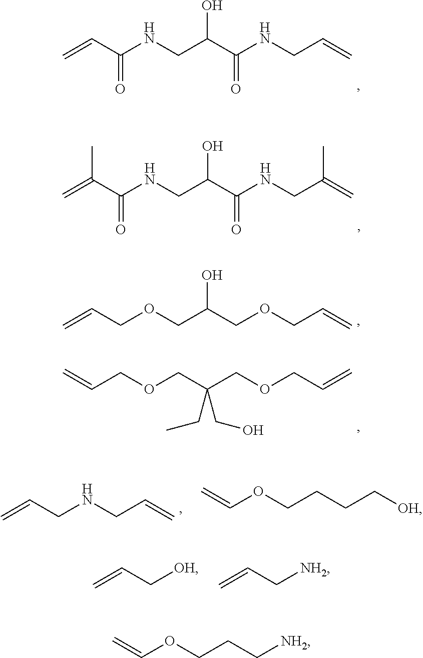
or a combination thereof.

7. The textile printing system of claim 1, wherein the ink composition can further comprise a photo-initiator, a sensitizer, or both.

8. The textile printing system of claim 1, wherein the fabric substrate includes cotton, polyester, silk, nylon, or a blend thereof.

9. A method of textile printing, comprising jetting an ink composition onto a fabric substrate, the ink composition, comprising:
from 50 wt % to 95 wt % water,
from 4 wt % to 49 wt % organic co-solvent,
from 0.5 wt % to 12 wt % pigment, wherein the pigment has a dispersant associated with a surface thereof, and
from 0.5 wt % to 20 wt % of a polyurethane particles, the polyurethane particles comprising a polyurethane strand including a polyurethane backbone with a pendant reactive (meth)acrylate-containing diol group and terminal end cap groups, the terminal end cap groups independently selected from a monoalcohol, a monoamine, an acrylate, a methacrylate, or a combination thereof.

10. The method of claim 9, wherein the polyurethane strand further comprises a carboxylated- or sulfonated-stabilization group appended thereto.

11. The method of claim 9, further comprising heating the ink composition on the fabric substrate at from 120° C. to 250° C. for from 1 seconds to 5 minutes.

12. The method of claim 9, further comprising underprinting or overprinting a binder fluid on the fabric substrate with respect to the ink composition, wherein the binder fluid is devoid of pigment and includes from 2 wt % to 30 wt % of the polyurethane particles dispersed therein

13. The method of claim 9, wherein the fabric substrate includes cotton, polyester, silk, nylon, or a blend thereof.

14. A textile printing system, comprising:
an ink composition, comprising:
from 50 wt % to 95 wt % water,
from 4 wt % to 49 wt % organic co-solvent,
from 0.5 wt % to 12 wt % pigment, wherein the pigment has a dispersant associated with a surface thereof, and
from 0.5 wt % to 20 wt % of a polyurethane particles, the polyurethane particles comprising a polyurethane strand including a polyurethane backbone with a pendant reactive (meth)acrylate-containing diol group and terminal end cap groups, the terminal end cap groups independently selected from a monoalcohol, a monoamine, an acrylate, a methacrylate, or a combination thereof;
a binder fluid that is devoid of pigment and includes from 2 wt % to 30 wt % of the polyurethane particles dispersed therein; and
a fabric substrate.

15. The textile printing system of claim 14, wherein the fabric substrate includes cotton, polyester, nylon, or a blend thereof.
